(19) United States
(12) Patent Application Publication
(10) Pub. No.: US 2007/0192065 A1
(43) Pub. Date: Aug. 16, 2007

(54) Embedded performance forecasting of network devices

(75) Inventors: Jamie D. Riggs, Longmont, CO (US); Michael Lehan, Centennial, CO (US)

Correspondence Address: HOGAN & HARTSON LLP, ONE TABOR CENTER, SUITE 1500, 1200 SEVENTEEN ST., DENVER, CO, 80202, US

(73) Assignee: Sun Microsystems, Inc.

(21) Appl. No.: 11/353,350

(22) Filed: Feb. 14, 2006

(51) Int. Cl. G06F 15/00

(52) U.S. Cl. 702/189

(57) ABSTRACT

A forecast engine is embedded in a networked device or in network component wherein the embedded forecast engine receives collected data concerning the device and applies forecasting techniques and methodologies to generate event forecasts particular to that device. The event forecasts are generated using device specific parameters and device specific time series to ascertain an event forecast that is representative of event pertinent to that device. Once generated, the event forecast is communicated to a central event manager which analyzes the forecast of each of the devices individually and as a member of the network so as to determine appropriate action to ensure and/or enhance network performance.

### BACKGROUND OF THE INVENTION

1. Field of the Invention

The present invention relates, in general, to the performance forecasting of network devices, and, more particularly, to software, systems and methods for embedded event forecasting of network components.

2. Relevant Background

More and more businesses and consumers alike use computers in their daily operations. Many of these computers are coupled together over networks that allow computers to share information and tasks with each other and with one or more central servers. As computers and computer networks become faster and more complex, more people depend on them to carry out critical operations and store critical data. The computing resources of a large business also represent a significant financial investment. When the business grows, resource managers must ensure that new resources are added as processing requirements increase. The fact that the growth and evolution of a computing platform is often rapid and irregular complicates management efforts including the ability to forecast events that may occur across the computing platform. This is especially true for computing platforms common to banking institutions and telecommunications companies whose computing platforms typically include hundreds of geographically distributed computers.

As computers and their networks increase in complexity, the potential of a critical event occurring in a computer, network and/or one of their components also rises. Computer components may fail or be degraded for many reasons including overheating, short-circuiting, and/or burning-out due to power surges. Computer components may also experience an event detrimental to the network because of over tasking, manufacturing defects, or accidents caused by users, such as, for example, dropping the computer, spilling fluids, etc. Additionally, an event in one component may lead to or cascade events in other components. For example, if a defective fan circulating air inside the computer fails, other computer components such as a power supply and/or a processor may also fail as the temperature increases. Similarly a network node or server may fail or be degraded resulting in more than acceptable transmission delays or over tasking of other nodes leading to unacceptable performance. Finally the network itself may fail to provide communication links between the individual computers or may provide degraded channels of communication due to a lack of communication bandwidth. Forecasting and preventing such events is thus highly desirable.

Predicting and preventing an event that may result in the failure or degradation of the network or one or more of its components is of significant value to businesses and individuals alike. Over the years, probabilistic techniques and systems have been developed for predicting variability and have been coupled with models of failure mechanisms to provide probabilistic models that predict the reliability of a population of nodes. Each of these systems follow the general model of centrally gathering data from each node or component, analyzing the data, and applying a probability model so as to predict component, node, or system failure. The forecasting entity normally stands at arms length away from the granular components of a network so as to develop a sense of the system and to assess adequate event criteria at a network level. Such a system provides an excellent impression of overall system performance but does little to understand the factors ongoing at any one node or single component of a system. This is further aggravated by inadequate or incomplete data collection due to network communication limits, degradation, or failure. Decreased/unavailable bandwidth may prevent critical data from being collected and analyzed leading to an unexpected component failure rather than a proactive identification and maintenance. Such reactive events are often unacceptable.

Computers typically do not have a way to internally detect a component that is failing, and thus, administrators of computers are normally forced to respond to a computer event after it occurs. Because administrators may not be able to respond to an event until after the event occurs, time and/or data may be lost. For example, an event may cause data stored in random access memory (RAM) to be lost, and/or data stored on a hard drive to become corrupted. A network communication failure may result in the inability for a node to complete its operations due to lack of data or other network orientated services despite being fully operational. For example, a failure in a network system (node) may result in a web server being unable to respond to increased demand of consumer requests resulting in lost sales and/or revenue. Reacting to a system failure or degradation, however fast and reliable, rather than proactively preventing its occurrence is insufficient when any failure however slight is unacceptable.

Conventional forecasting tools are also limited by the amount of data they can process. For example, some forecasting tools may not adequately purge older or non-essential data. Other forecasting tools may not appropriately incorporate new data as it becomes available or be flexible enough to apply the optimal forecasting tool for each component. Still other forecasting tools may not have the computing power to perform calculations on large amounts of data collected from each node forcing the accuracy of the forecast to suffer.

For example, a network of 1000 nodes in a network may each provide 10 different types of performance data to a central server which predicts component and network degradation/failure on these factors. The selection of what data to collect may vary from system to system but typically a single data collection criteria is consistently applied to each node in the network. The advantage of uniformity of information comes at the price of failing to realize that each node is unique and experiences unique events. While it is theoretically possible to collect immense amounts of information about each and every node so as to make the forecast more representative and reliable, reality prevents the implementation of such a system. The bandwidth requirements to collect such amounts of data would likely strain the system and the latency in processing such a large volume of data would render the result obsolete before it could be acted upon. Furthermore, the trending of data for each individual component is lost when the network carrying the information is down or the collecting server is nonfunctional.

Given the diversity of nodes in any given network, a prediction of the reliability of a population says little about the future life of an individual member of the population. Safety factors are likewise unsatisfactory methods for predicting the life of an individual component since they are based on historical information obtained from a population and not from or applied to an individual component. Furthermore, such safety factors normally rely on historical information obtained from test components, not data specific to each individual component.

What is needed are systems and methods for stable, accurate and reliable embedded event forecasting for devices in a network. Systems and methods are needed that can be embedded in individual components of a network that can accurately and reliably forecast events and communicate that forecast to a central event manager so that the network and overall system can take proactive measure to ensure overall system reliability and performance before an undesirable event is realized.

### SUMMARY OF THE INVENTION

Briefly stated, the present invention involves computer implemented methods, systems, and computer media for embedded event forecasting of networked devices. A forecast engine is embedded in a networked device or in a network component wherein the embedded forecast engine receives collected data from and concerning the device. Once the data is collected, the forecast engine applies forecasting techniques and methodologies to generate event forecasts particular to that device. Event forecasts are generated using device specific parameters and device specific time series models to ascertain an event forecast that is representative of events pertinent to that device rather than the network as a whole. Once generated, the event forecast is communicated to a central event manager which analyzes the forecast of each the devices individually and as a member of a network so as to determine appropriate action to ensure and/or enhance network performance and reliability.

In one embodiment of the present invention, the embedded forecast engine conducts a device level analysis of the forecasts produced and determines which event forecasts are communicated to the central event manager. In another embodiment of the present invention, the central event manager, based on event forecasts from one or more devices, directs the generation of one or more event forecasts at a different device. The central event manager further modifies network characteristics, configurations, tasks, loads, and other various aspects of a network based on the received and analyzed event forecasts. In yet another embodiment of the present invention the central event manager proactively manipulates the network, including repair and/or replacement of devices within the network, based on the received forecasts before a forecast event occurs.

These foregoing and other features, utilities and advantages of the invention will be apparent from the following more particular description of one or more embodiments of the invention as illustrated in the accompanying drawings. The features and advantages described in this disclosure and in the following detailed description are not all-inclusive and many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 shows a high level networked computer environment in which the present invention is implemented;

FIG. 2 shows a network environment for managing forecasted events of at least one device in which the present invention is implemented;

FIG. 3 shows a network cluster environment for managing forecasted events of at least one device and/or cluster in which the present invention is implemented;

FIG. 4 shows a high level block diagram of an embedded forecast engine for managing forecasted events of at least one device in a network environment in which one embodiment of the present invention is implemented;

FIG. 5 shows a flow chart of one embodiment of the present invention of a method for collecting data and forecasting events at a device in a network environment; and

FIG. 6 shows a flow chart of one embodiment of the present invention of a method for analyzing data and managing forecasted events received from one or more devices in a network environment.

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

An embedded forecast engine 100 sited at one or more devices in a network collects and analyzes data independently at each device to forecast pertinent device events. Each device communicates generated event forecasts to a centralized event manager that collects and further analyzes the individual device event forecasts as applied to the network and/or the centralized event manager's area of responsibility. The central event manager modifies network configurations, task assignments, memory allocations, routing assignments, repair/replacement orders, etc. on a proactive and preventative basis so as to maximize network/system performance and reliability.

It is to be understood that although the embedded forecast engine 100 is illustrated as a single entity, as the term is used herein an embedded forecast engine 100 refers to a collection of functionalities that can be implemented as software, hardware, firmware or any combination of the aforementioned. Where the embedded forecast engine 100 is implemented as software, it can be implemented as a standalone program, but can also be implemented in other ways, for example as part of a larger program, as a plurality of separate programs, as one or more device drivers or as one or more statically or dynamically linked libraries. An embedded forecast engine 100 can be instantiated on and/or as part of a server, client, domain, proxy, gateway, switch and/or any combination of these and/or other computing devices and/or platforms.

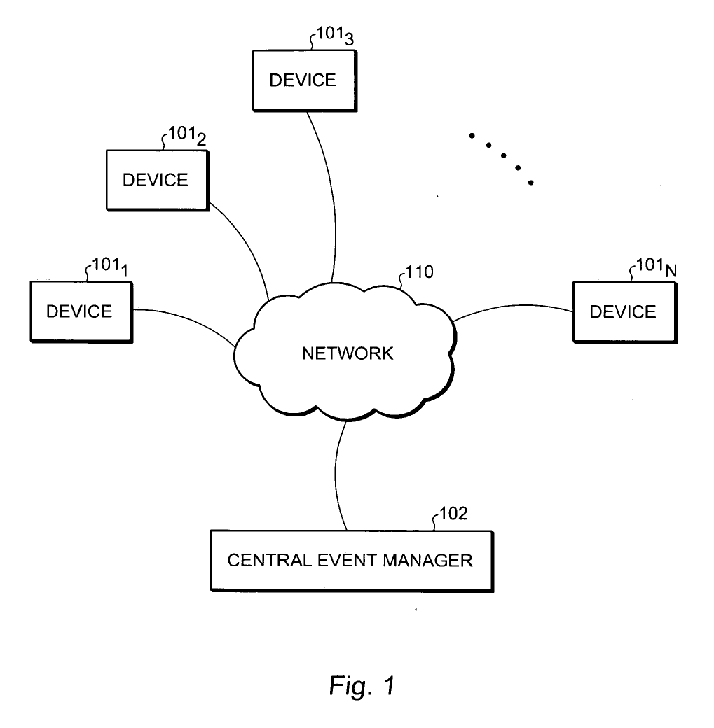

FIG. 1 shows a high level network diagram in which the present invention may be implemented. While the embedded forecast engine 100 is described herein in terms of a computer orientated network 110 such as a Intranet or the Internet, the concepts and functionality of the present invention can be implemented in any network environment that communicates information and data pertaining to events occurring at each device 101₁, 101₂, 101₃ . . . 101ₙ to an event manager 102 that in turn manages overall network operations.

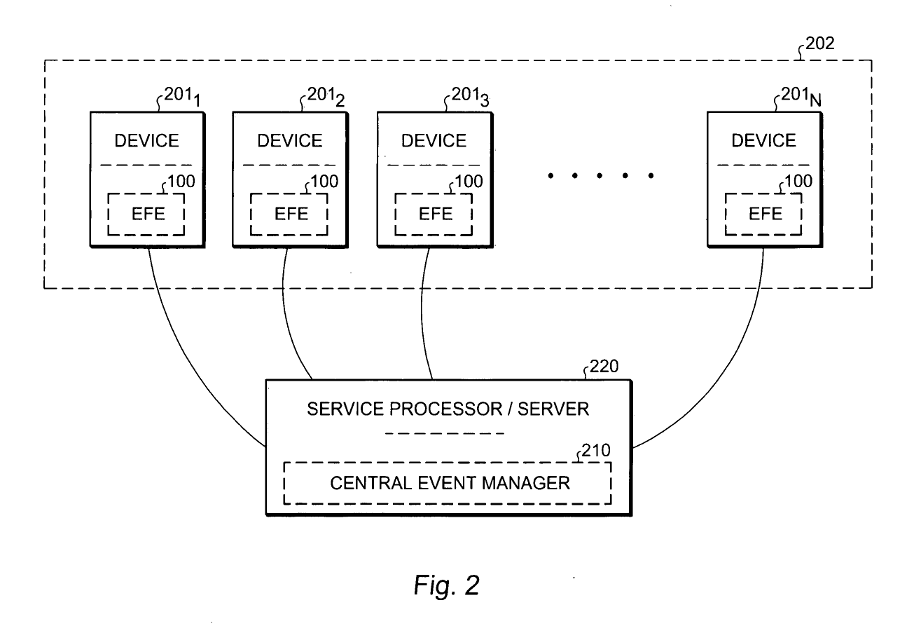

FIG. 2 shows a computer network environment for managing forecasted events of at least one device in which the present invention is implemented. An embedded forecast engine 100 is sited in each device 201₁, 201₂, 201₃, . . . 201ₙ for the purpose of generating device specific event forecasts. Each forecast engine 100 collects and analyzes data at each device 201 creating forecasts of events pertinent to that device. The forecasts produced at each device and the methodologies used to generate those forecasts are particularly orientated to the operations and environment of that device 201. Each device 201, or group of devices 202, is communicatively coupled to a central event manger 210 and conveys individual device event forecasts to the central event manager 210 for network level analysis or analysis of the central event manager's area of responsibility. While each device depicted in FIG. 2 is shown as a single component or computer it may equally represent a collection of devices possessing similar functionalities or characteristics such as a storage area network or cluster of devices that report data to a single location for analysis. As shown in FIG. 2, each device, component, or domain (used synonymously in this description) conveys forecasted events to a service processor/server 220 that houses the central event manager 210. Each device 201 in this embodiment, including the service processor/server, comprises an operating system on which the embedded forecast engine 100 or central event manager operates.

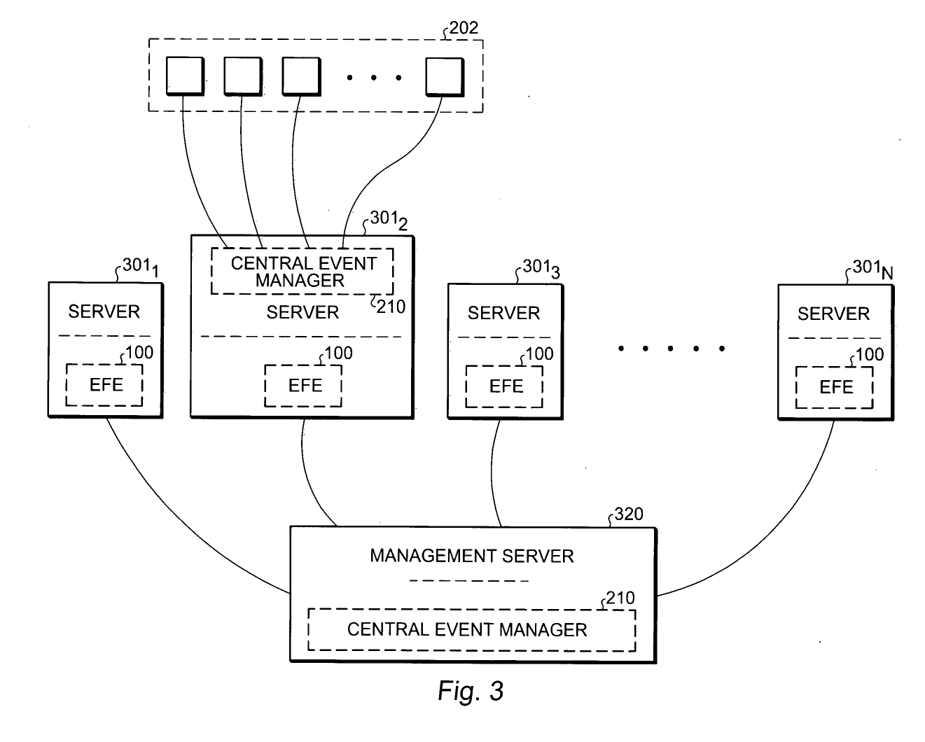

FIG. 3 depicts a clustered network environment in which the present invention for managing device events may be implemented. In the cluster environment of FIG. 3, the embedded forecast engine 100 can be sited with each server's service processor and shared among several devices 202. Each server 301₁, 301₂, 301₃, . . . 301ₙ. can also possess a separate embedded forecast engine 100 coupled to a separate management server 320 housing yet another central event manager 210 for these associated servers 301. In similar fashion the present invention is scalable at multiple layers of a network while retaining its ability to tailor and evaluate event forecasting at both a component and network level. Significantly, the embedded forecast engine 100 does not collect and merely communicate data to a central manager for analysis but generates unique forecasts pertinent to each device or region and subsequently communicates these forecasts to a central event manager.

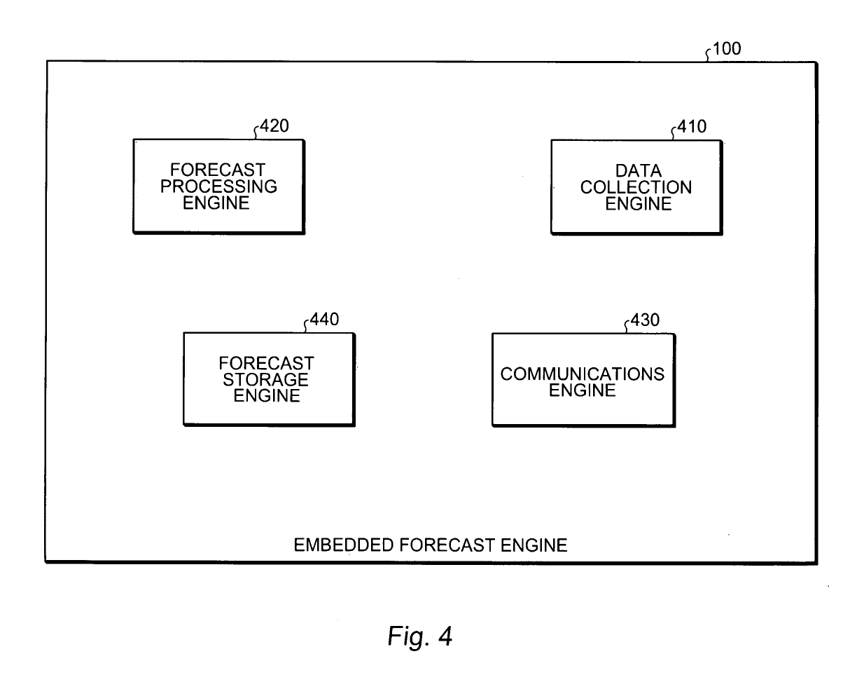

In an exemplary embodiment of the present invention, a forecast engine is embedded in each device or component in a network. The embedded forecast engine 100 comprises, in one embodiment and as shown in FIG. 4, a data collection engine 410, a forecast processing engine 420, a communications engine 430 and a forecast storage engine 440. Each embedded forecast engine of each device independently determines relevant event forecasts for that device. These forecasts are selectively communicated to the central event manager 210 which interprets the forecasts and acts to modify the network or component to improve efficiency, performance and/or reliability. The central event manager 210 can further convey to each device's embedded forecast engine network updates and forecast modifications/criteria based on global network configuration needs.

Data from each device is obtained through device diagnostic or monitoring methodologies that will be known and readily apparent to one skilled in the relevant art. Data is collected by the data collection engine 410 on either a periodic or event driven schedule and is communicated to the forecast processing engine 420 for generation of one or more event specific forecasts. These forecasts are in turn communicated to a central event manager 210 by the communication engine 430 where the impact of the event on the network is considered. The central event manager 210 produces, in one embodiment of the present invention, a graphical representations of events prior to the forecasted event of concern for user interpretation. Forecasts can also be stored 440 by each embedded forecast engine 100 and/or the central event manger 210 for trend analysis.

As an example to better understand the functionality and usefulness of the embedded forecast engine 100, consider an interest in forecasting memory failure rates of individual components in a network environment containing 1000 devices. In a typical forecasting model, each device collects and communicates to a central manager predetermined data reflective of, or indicative of, memory failure. Due to bandwidth communication and latency limits the types of and quantity of data collected at each device must be both limited and consistent throughout the network. Characteristics such as memory failure rates can be system-load dependent, and hence, are ideal for event prediction. Events associated with memory failures can be forecasted directly from a history of memory failure events. System loads associated with such a failure can be considered an intervention event that may modify memory failure behavior. The prediction of a memory failure is thus interested in data pertaining to all of these events. The reliability and accuracy of a forecast generated from globally collected data however becomes less and less useful toward predicting individual device failure as the number of devices increases due to real world constraints on the limit of data that can be collected and analyzed at a central location.

The weighted value of each of these characteristics of memory failure and/or other characteristics that are not herein considered often vary from one device to another. The forecast generated from a consistent collection from all of the devices is thus not an accurate forecast as to the memory failure of any one device. The embedded forecast engine 100 system, in one embodiment of the present invention, uses load forecasting combined with memory failure forecasting at each device to provide a forecast that is individually more reliable than either a network based memory failure forecast or load forecast. Furthermore, the combination of load forecasting and memory failure forecasting can be tailored to each device further enhancing its usefulness. The forecast is therefore device independent and thus provides a granular component by component forecast of memory failure for further analysis rather than a network forecast that foretells a memory failure of one unspecified component. Memory management can be enhanced by replacing or repairing memory components forecast to fail prior to the component's actual failure. An individual component forecast, as opposed to an overall system memory failure forecast, provides a component by component analysis of network devices allowing proactive component intervention rather than a network based reaction. As an illustration, a network wide forecast is likely to accurately predict that 10 of the 1000 components will have memory failure. The forecast however will be unable to identify in which of the 1000 devices the failure will occur. The present invention not only provides the ability to predict the scope of the memory failure experienced by the network but further identify the exact devices, and the components in those devices, in which memory failure will occur.

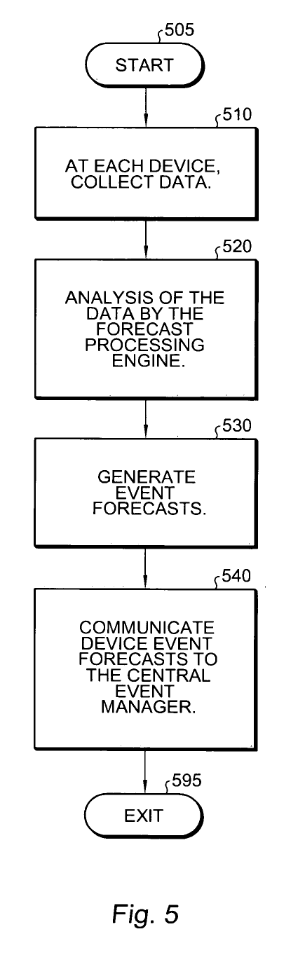

FIG. 5 shows a flow chart of one method embodiment for collecting data and forecasting events at a device in a network environment. Data pertinent to an event being forecast is collected 510 and presented for analysis by the embedded forecast engine 100. The forecast processing engine 420 generates a forecast as a new event independent of events on which previous forecasts were based and independent of other devices. The forecast distribution typically has a mean and a variance that are estimated from the combined errors of the events. Forecast limits based solely on the forecast distribution variance are not typically used as there is a variance in the possible location of the distribution of the forecast and there is a variance within the probability distribution of the forecasts distribution. Therefore, a forecast interval must be considered in determining accuracy of any single event forecast for any single device.

Forecast intervals resemble confidence intervals as known to one skilled in the art but differ in that they represent an inference of a parameter, such as an average, that is intended to cover the value of the parameter. A forecast interval is a statement about the value to be taken (predicted) by a random variable. Three attributes of each existing and future variables are examined to sufficiently estimate the behavior and characteristic of each variable's forecast distribution. These attributes include autocorrelation within each variable, the probability distribution of each variable, and the homogeneity of variance within each variable. The forecast processing engine considers each of these attributes in generating each event forecast pertinent to that device.

As the forecast processing engine 420 generates event forecasts, the data collection engine 410 conducts periodic data audits to identify changes not only in the process that causes the data to change, but also to identify turning points for exception limit changes and changes in the probability distribution of the data. Other time-based statistical analyses known to one skilled in the art can be used and are contemplated for use by the embedded forecast engine 100. Such differing methodologies are equally applicable for use with the present invention and do not alter or limit the scope of the present invention.

The forecast processing engine 420 examines device data, chooses exception limits and characterizes probability distributions. A time series model that best describes the event behavior, if it exists, is also selected. Once data behavior is characterized, the forecast processing engine 420 of the embedded forecast engine 100 accepts the scrubbed data, the location of where the event forecast will reside in the device for future analysis, the transformation type, and the time series model type and parameters. The data is then accrued into a defined period in which the beginning date, the ending date, and the number of intervening periods in the data set are identified. The data is transformed and event forecasts are generated 530 from the time series model type and parameters for each device.

The event forecast for any one device is unique to that event for that device. The time series model, the data characterization, parameters, etc. are specific and optimized for the forecast generated for each device possessing an embedded forecast engine 100. In another embodiment of the present invention, forecasts can be constrained by the central event manger 210 to be consistently generated across a select set of devices. Once an event forecast is generated, the forecast storage engine 440 retains the forecast for trend analysis and passes the forecast to the communication engine 430 which communicates the forecast(s) to the central event manager 210. The central event manager 210 receives the forecast and determines whether the event forecasted may impact the network and whether proactive measures are warranted.

In another embodiment of the present invention, the embedded forecast engine 100 conducts an analysis of the forecasts generated by the forecast processing engine 420 to determine whether or not the forecast should be communicated to the central event manager 210. Forecasted events meeting reporting criteria are forwarded to the central event manager 210 for further action while other forecast are maintained and monitored at the component level thus further limiting unnecessary network communication.

User presentation formats for each event forecast at both the device level and the network level can vary according to various user needs but typically includes a plot with the most recent time intervals of data including the forecasts with appropriate exception limits.

The following sections present the mathematics behind the techniques used above. Other statistical methods known to one skilled in the relevant art may be used in addition to, or in lieu of, the methods described below and are each equally compatible with the present invention.

As previously described, scrubbed data are accrued into specified time periods and then best-fit statistics determine the appropriate probability distribution, when one exists. The best-fit statistics include the Shapiro-Wilk statistic for testing for a normal distribution. Kolmogorov-Smirrov, Cramen-von Mises, and Anderson-Darling statistics are used for testing exponential, lognormal, and Weibull distributions respectively. For any distribution that is not normal, data transformations such as the raperian logarithm (natural logarithm) are applied. When a distribution defies classification, the data are still subjected to time series analysis to see whether seasonality or other difference transformations provides a model that reduces to white noise. When these techniques fail, a straight Exponentially Weighted Moving Average (“EWMA”) model is used.

The EWMA is a statistic for monitoring a process that averages the data in a way that gives less and less weight to observations as they are further removed in time from the current observation. Unlike Shewhart charts, the EWMA chart can be used on non-stationary data as the means of the observation subgroups drift and on the variance is non-constant through the span of the data.

The state of control of a process at any time depends on the EWMA statistic, which is an exponentially weighted average of all prior data, including the most recent measurement. The center-line of the EWMA chart is set to a target level, on the grand mean of the historical observations. Upper and lower exception limits are calculated to indicate when a process shift is significant. The choice of weighting factor for the EWMA control procedure can be made sensitive to a small or gradual shift in the process, or it can be made to respond to every shift. The weighting factor is chosen so as to minimize the mean square error (“MSE”) between historical observations and the forecasts resulting from a range of trial weighting factors.

Consider a random sample X₁, . . . , Xₙ. We want to predict Xₙ₊₁. It can be shown that the conditional expectation of Xₙ₊₁, given X₁, . . . , Xₙ, is a Best Linear Unbiased Estimate (BLUE). The predicted value of Xₙ₊₁, viz., \hat{X}ₙ₊₁ is best in the sense that it minimizes the Mean Square Error, i.e.,
\hat{X}ₙ₊₁=E[Xₙ₊₁|X₁ . . . , Xₙ]
minimizes
E[(Xₙ₊₁−\hat{X}ₙ₊₁)²]

Now consider the ARIMA(0,1,1) first order moving average process {Xₜ},
∇Xₜ=(1−θB)Zₜ {Zₜ}˜wn(0,σ²),
Xₜ−Xₜ₋₁=Zₜ−θZₜ₋₁
where wn refers to white noise with mean 0, variance σ², that is uncorrelated (but not necessarily independent) among successive values of Zₜ. This form of the process shows that {Xₜ} is invertible and hence has the equivalent form

$${X}_{t} = {\sum }_{j = 1}^{∞} {π}_{j} {X}_{t - j} + {Z}_{t}$$

where
πⱼ=(1−θ)θ^{j-1}=λ(1−λ)^{j-1}, j≧1

So the process may be written

$${X}_{t} = λ {\sum }_{j = 1}^{∞} {( 1 - λ )}^{j - 1} {X}_{t - j} + {Z}_{t}$$

The weighted moving average of previous values of this process is an exponentially weighted (or geometrically weighted) moving average. For time t, then, this model is,
Xₜ=Xₜ₋₁+Zₜ−θZₜ₋₁

To forecast the next interval t+1, we advance the index by one and get
Xₜ₊₁=Xₜ+Zₜ₊₁−θZₜ

We do not know Zₜ₊₁ as this interval has not yet occurred, but we do know that it has mean zero and it is uncorrelated with what has occurred. Using a mean of zero, the best forecast of \hat{X}ₜ₊₁ is
\hat{X}ₜ₊₁=Xₜ−θZₜ

Subtracting \hat{X}ₜ₊₁ from X₊₁ we have
Zₜ₊₁=Xₜ₊₁−\hat{X}ₜ₊₁
which implies
Zₜ=Xₜ−\hat{X}ₜ

The error Zₜ measures the difference between what actually happened in any given interval and the forecast from the previous interval to the given interval.

Substituting in the following way, we have
\hat{X}ₜ₊₁=Xₜ−θ(Xₜ−\hat{X}ₜ)=(1−θ)Xₜ+θ\hat{X}ₜ

The forecast is obtained for the next interval by taking the weighted average of what just happened with what was predicted for this current interval.

Typically, the central line on the EWMA charts indicate an estimate for μ, including subgroup mean drifts, which is computed from historical data as

$$\hat{μ} = \overline{\overline{X}} = {\sum }_{i = 1}^{N} \frac{{n}_{i} {\overline{X}}_{i}}{{n}_{i}}$$

The control limits typically are computed as three times the standard error of Zₜ above and below the central line. These are often referred to as 3σ limits. These formulas assume that the data are normally distributed. If the subgroup sample sizes are constant (nᵢ=n), the formulas for the control limits simplify to
LCL= X̅=3\hat{σ}\sqrt{θ/n(2−θ)}
UCL= X̅+3\hat{σ}\sqrt{θ/n(2−θ)}
where \hat{σ} is the standard deviation of the historical data. The areas that lie outside the upper and lower control limits are colored red for easy identification.

Another embodiment for identification, estimation, and forecasting time series data compatible with the present invention is known as Autoregressive Integrated Moving Average modeling, and denoted as ARIMA. The basic tools for ARIMA modeling are the autocorrelation and partial autocorrelation functions. The Autocorrelation Function (ACF) is an indicator of the degree of autocorrelation present in a time series. The Partial Autocorrelation Function (PACF) is the other diagnostic tool that can be thought of as a corrected autocorrelation between present and past values of a times series. The PACF essentially conditions the intervening observations between the present and the past observations of interest.

A sub-class of ARIMA models are ARMA models. These models don't have the integrated part in them, which implies these models are stationary in time. The process {Xₜ, t=0, ±1, ±2, . . . } is considered an ARMA(p,q) process if the random sequence {Xₜ} is stationary, and if for every t,
Xₜ−φ₁Xₜ₋₁ −. . . −φₚXₜ₋ₚ=Zₜ+θ₁Zₜ₋₁ +. . . +θ_{q}Z_{t-q}
where {Zₜ}˜ WN(0,σ²), and WN denotes white noise with mean 0 and variance σ². The equation can be written in more compact form as
φ(B)Xₜ=θ(B)Zₜ, t=0, ±1, ±2, . . .
where φ and θ are the p^{th} and q^{th} degree polynomials σ(r)=1−σ₁r−. . . −φₚr^{p}, θ(r)=1+θ₁r+. . . +θ_{q}r^{q}, and B is the backward shift operator defined as
B^{j}Xₜ=Xₜ₋ⱼ, j=0, ±1, ±2, . . .
φ is the autoregressive polynomial, and θ is the moving average polynomial.

The moving average process, MA(q) is when φ(r)≡1 so Xₜ=θ(B)Zₜ, and the process is said to be a moving average process of order q. The autoregressive process, AR(p) is when θ(r)≡1 so φ(B)Xₜ=Zₜ, and the process is said to be an autoregressive process of order p.

When the data show themselves to be stationary and the autocorrelation function is rapidly decreasing, then we have a high likelihood of finding a suitable ARMA model. However, when we have a non-stationary system or the autocorrelation function decreases slowly, then we may be able achieve an ARMA process by differencing the data, which gives us the class of ARIMA models. After transforming the data, the problem becomes finding a suitable stationary ARMA(p,q) model, specifically, find the values for p and q.

A process {Xₜ} is considered an ARIMA(p,d,q) process when Yt:=(1−B)^{d}Xₜ can be show to be an ARMA(p,q) process. This means that {Xₜ} has the form of the difference equation
φ*(B)Xₜ≡φ(B)∇^{d}Xₜ=φ(B)(1−B)^{d}Xₜ=θ(B)Zₜ, {Zt}˜WN(0,σ²)
where σ(r) and θ(r) are polynomials of degrees p and q respectively, as before.

The polynomial σ * (r) has a zero of order d at r=1.

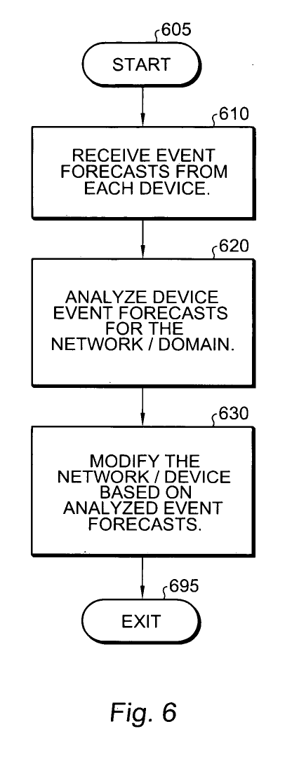

The generation and communication of event forecasts by each device to the central event manager 210 provide the central event manager the ability to analyze network wide event forecasts and identify devices or components that place network performance at risk. The central event manager 210 can thereafter act proactively to correct noted and/or forecast deficiencies within the network and/or within individual components. FIG. 6 shows a high level flow chart of one embodiment for managing event forecasts to accomplish this management.

The central event manager 210 receives 610 event forecasts from each device and analyzes 620 them to ascertain the impact that the individual events will pose on the network. Based on this analysis, the central event manager 210 modifies 630 network or device configurations and assignments to prevent network degradation or failure. The central event manager 210 also acts as a conduit of event forecast information to other event managers located throughout the hierarchal structure of a network. In another embodiment, the central event manager 210 proactively orders device repair or replacement prior to a forecasted event occurring. In yet still another embodiment of the present invention, the central event manager 210 can elicit event forecast from select device based on existing event forecasts from similar devices. Proactive or preventative action rather than reactive repairs minimize system down time and enhance overall performance.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

Likewise, the particular naming and division of the modules, managers, functions, systems, engines, layers, features, attributes, methodologies and other aspects are not mandatory or significant, and the mechanisms that implement the invention or its features may have different names, divisions and/or formats. Furthermore, as will be apparent to one of ordinary skill in the relevant art, the modules, managers, functions, systems, engines, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

1. A method for managing forecasted events of at least one device in a network, the method comprising the steps of:
embedding in each device a forecast engine, wherein each forecast engine collects device specific performance data and analyzes the device specific performance data;
determining at each device, a forecast of an event for the device based on the analysis of device specific performance data;
communicating the forecast of the event of each device to a central event manager;
analyzing the event forecast of each device; and
responsive to analyzing the events forecast of each device, modifying the network providing proactive device intervention.

2. The method of claim 1 wherein the forecast engine for each device is a statistically-based engine and wherein the forecast engine is selected based on device functionality.

3. The method of claim 1 wherein analyzing includes determining event trend information for each device.

4. The method of claim 1 wherein analyzing includes determining event trend information for the network based on individual device forecasted events.

5. The method of claim 1 wherein the event comprises failure of the device and wherein modifying includes repairing or replacing the at least one device forecasted to fail prior to device failure.

6. The method of claim 5 wherein modifying includes altering tasks assigned to the at least one device forecasted to fail prior to device failure.

7. The method of claim 5 wherein modifying includes changing memory assignments of the at least one device forecasted to fail prior to device failure.

8. At least one computer-readable medium containing a computer program product for managing forecasted events of at least one device in a network, the computer program product comprising:
program code for embedding in each device a statistically-based forecast engine, wherein each forecast engine collects device specific performance data and analyzes the device specific performance data;
program code for determining at each device, a forecast of an event of the device based on the analysis of the device specific performance data;
program code for communicating the forecast of the event of each device to a central event manager;
program code for analyzing the event forecast of each device at the central event manager; and
responsive to analyzing the event forecast of each device, program for proactively modifying the network.

9. The computer program product of claim 8 further comprising program code for selecting the forecast engine for each device based on device functionality.

10. The computer program product of claim 8 wherein the program code for analyzing further includes program code for determining event trend information for each device.

11. The computer program product of claim 8 wherein the program code for analyzing further includes program code for determining event trend information for the network based on individual device forecasted events.

12. The computer program product of claim 8 wherein the event comprise failure of the device and the program code for modifying includes program code for repairing or replacing the at least one device forecasted to fail prior to device failure.

13. The computer program product of claim 12 wherein the program code for modifying further includes program code for altering tasks assigned to the at least one device forecasted to fail prior to device failure.

14. The computer program product of claim 12 wherein the program code for modifying further includes changing memory assignments of the at least one device forecasted to fail prior to device failure.

15. A computer system for managing forecasted events in a network, the computer system comprising:
a software portion executable on a computer processor configured to embed in each of a plurality of devices in the network a statistically-based forecast engine, wherein each forecast engine collects device specific performance data and analyzes the device specific performance data;
a software portion configured to determine at each device, a forecast of an event of the device based on the analysis of the device specific performance data;
a software portion configured to communicate the forecast of the event of each device to a central event manager wherein the central event manager is a server in communication with the network;
a software portion configured to analyze the forecasted events of each device; and
responsive to analyzing the forecasted events of each device, a software portion configured to modify the network.

16. The computer system of claim 15 further comprising a software portion configured to select the forecast engine for each device based on device functionality.

17. The computer system of claim 15 further comprising a software portion configured to determine event trend information for each device.

18. The computer system of claim 15 wherein the software portion configure to analyze further comprises a software portion configured to determine event trend information for the network based on individual device forecasted events.

19. The computer system of claim 15 wherein the event comprises device failure and wherein the software portion configured to modify the network further comprises a software portion configured to repair or replace the at least one device forecasted to fail prior to device failure.

20. The computer system of claim 19 wherein the software portion configured to modify the network further comprises a software portion configured to alter tasks assigned to the at least one device forecasted to fail prior to device failure to prevent or delay device failure.
